(19) United States
(12) Patent Application Publication
(10) Pub. No.: US 2025/0042090 A1
(43) Pub. Date: Feb. 6, 2025

(54) VOLUMETRIC THREE-DIMENSIONAL BIOPRINTING DEVICE

(71) Applicant: GUANGZHOU MEDICAL UNIVERSITY, Guangzhou (CN)

(72) Inventor: Maobin Xie, Guangzhou (CN)

(21) Appl. No.: 18/921,040

(22) Filed: Oct. 21, 2024

Related U.S. Application Data
(63) Continuation-in-part of application No. PCT/CN2022/131149, filed on Nov. 10, 2022.

(30) Foreign Application Priority Data
Apr. 19, 2022 (CN) 202210414225.6

(51) Int. Cl. B29C 64/268; B29C 64/135; B29C 64/241; B33Y 30/00

(52) U.S. Cl. CPC B29C 64/268; B29C 64/135; B29C 64/241; B33Y 30/00; B29K 2995/0056

(57) ABSTRACT

Provided is a volumetric three-dimensional bioprinting device. The volumetric three-dimensional bioprinting device includes a printing bottle (20) for containing bioink (10), a rotation unit for carrying and rotating the printing bottle (20) at a preset speed, a focusing unit and a control unit electrically connected to the rotation unit and the focusing unit. The focusing unit is used for enabling an energy beam (30) to pass through at least one preset position of the printing bottle (20), so that the bioink in the at least one preset position can be cured at the same time to form a three-dimensional object (100). The control unit determines projection modes matched with the rotation speed of the printing bottle according to a Radon transformation formula, and then controls the focusing unit to output the energy beam in the projection modes.

### CROSS-REFERENCE TO RELATED APPLICATIONS

The present application is a Continuation-In-Part application of PCT application No. PCT/CN2022/131149 filed on Nov. 10, 2022, which claims the benefit of Chinese Patent Application No. 202210414225.6 filed on Apr. 19, 2022, the contents of which are hereby incorporated by reference.

### FIELD OF THE PRESENT INVENTION

The invention belongs to the technical field of biomedical engineering, and specifically relates to a volumetric three-dimensional bioprinting device.

### BACKGROUND OF THE PRESENT INVENTION

The emergence of additive manufacturing technology has promoted the development and applications of biomedicine, ranging from medical devices to bioprinting of tissues and organs. Traditional three-dimensional bioprinting device generally adopts layer-by-layer printing, and contacts exist between the printing device and the bioink and between the printing device and a formed three-dimensional object during the printing process, thereby increasing the risk of biological contamination. At the same time, layer-by-layer printing generally has the characteristic of slow printing speed, which affects the speed of three-dimensional bioprinting.

Therefore, it is desirable to provide a printing device that can achieve contactless printing with bioink and a three-dimensional object formed later, and has a faster printing speed.

### SUMMARY OF THE PRESENT INVENTION

The object of the present disclosure is to solve at least one of the technical problems existing in the above-mentioned prior art. Therefore, the invention provides a volume three-dimensional bioprinting device, which realizes the contactless printing of the volumetric three-dimensional bioprinting through the cooperation of a printing bottle, a rotation unit, a focusing unit and a control unit, avoids the risk of biological contamination and greatly improves the speed of bioprinting.

The object of the present disclosure is achieved by the following technical solutions.

A volumetric three-dimensional bioprinting device provided by the present disclosure includes a printing bottle, a rotation unit, a focusing unit and a control unit. The printing bottle is used for containing bioink; the rotation unit is used for carrying and rotating the printing bottle at a preset speed; the focusing unit is used for enabling the energy beam to pass through at least one preset position of the printing bottle, so that bioink in the at least one preset position can be cured at the same time to form a three-dimensional object. The control unit and the rotation unit are electrically connected to the focusing unit.

According to some embodiments of the present disclosure, the focusing unit is used for projecting a plurality of dynamically varying two-dimensional patterns to a specific portion of the bioink corresponding to the preset position of the printing bottle.

According to some embodiments of the present disclosure, the volumetric three-dimensional bioprinting device continuously rotates the printing bottle containing the bioink by the rotation unit, projects a plurality of dynamically varying two-dimensional patterns to a specific portion of the bioink by the focusing unit so that the two-dimensional patterns are perpendicular to the rotation axis of the printing bottle, and determines a projection mode matched with a rotation speed of the printing bottle according to a Radon transformation formula to control the focusing unit to output the energy beam in the projection mode by the control unit. After the bioink in the printing bottle is irradiated by the energy beam for a certain time, a three-dimensional distribution of the accumulated light dose will be generated, resulting in photo-crosslinking of the specific portion of the bioink, and then a three-dimensional object is formed at the specific portion at the same time.

According to some embodiments of the present disclosure, the energy source of the energy beam is at least one of a bulb, a light emitting diode, an LCD or a laser emitter.

According to some embodiments of the present disclosure, the energy beam passes through the printing bottle after being focused by a convex lens or a plane mirror.

According to some embodiments of the present disclosure, the wavelength of the energy beam is 390-780 nm.

According to some embodiments of the present disclosure, the focal length of the energy beam is 4-9.2 cm.

According to some embodiments of the present disclosure, the rotation unit includes a moving platform to adjust the spatial position of the energy beam and the printing bottle.

According to some embodiments of the present disclosure, the rotation unit adjusts the spatial positions of the energy beam and the printing bottle by changing the axial distances of an X-axis, a Y-axis, and a Z-axis of the moving platform.

According to some embodiments of the present disclosure, the spatial position of the energy beam and the printing bottle is adjusted to be closer to or further away from the printing bottle.

According to some embodiments of the present disclosure, the spatial position of the energy beam and the printing bottle is adjusted to a position closer to an upper, lower, left or right portion of the printing bottle.

According to some embodiments of the present disclosure, the printing bottle is made of transparent plastic or glass.

According to some embodiments of the present disclosure, the bioink includes a polymer precursor to be photocured and a microorganism.

According to some embodiments of the present disclosure, the bioink includes a polymer precursor to be photocured and at least one of cells or bacteria.

Compared with the prior art, the beneficial effects of the present disclosure are as follows:
(1) the volumetric three-dimensional bioprinting device of the present disclosure realizes the simultaneous formation of three-dimensional object through the cooperation of a printing bottle, a rotation unit, a focusing unit and a control unit, and the printing device conducts contactless printing with the formed three-dimensional object, thereby preventing biological contamination;
(2) the volumetric three-dimensional bioprinting device of the present disclosure has a fast volumetric three-dimensional bioprinting speed, and realizes the printing of a three-dimensional object with a size of a centimeter level in tens of seconds;
(3) the volumetric three-dimensional bioprinting device of the present disclosure is applicable to the printing of complex structures, and forms three-dimensional objects which have smooth surfaces and resolutions of 50 μm, and is suitable for industrial popularization and use.
(4) the volumetric three-dimensional bioprinting device of the present disclosure is applicable to the printing of three-dimensional objects of various sizes.

### BRIEF DESCRIPTION OF THE DRAWINGS

In order to more clearly illustrate the technical solutions of the embodiments of the present disclosure, the drawings that are needed in the embodiments will be briefly described below, it being understood that the following drawings only illustrate some embodiments of the present disclosure and therefore should not be considered as limiting the scope, and other related drawings may be obtained according to these drawings without inventive effort for a person skilled in the art.

FIG. 1 is a schematic view of a printing process of a volumetric three-dimensional bioprinting device according to some embodiments of the present disclosure;

FIG. 2 is a first schematic structural view of a volumetric three-dimensional bioprinting device according to some embodiments of the present disclosure;

FIG. 3 is a second schematic structural view of a volumetric three-dimensional bioprinting device according to some embodiments of the present disclosure;

FIG. 4 is a third schematic structural view of a volumetric three-dimensional bioprinting device according to some embodiments of the present disclosure;

FIG. 5 is a fourth schematic structural view of a volumetric three-dimensional bioprinting device according to some embodiments of the present disclosure;

FIG. 6 is a fifth schematic structural view of a volumetric three-dimensional bioprinting device according to some embodiments of the present disclosure;

FIG. 7 is a sixth schematic structural view of a volumetric three-dimensional bioprinting device according to some embodiments of the present disclosure;

FIG. 8 is a seventh schematic structural view of a volumetric three-dimensional bioprinting device according to some embodiments of the present disclosure;

FIG. 9 is an eighth schematic structural view of a volumetric three-dimensional bioprinting device according to some embodiments of the present disclosure;

FIG. 10 is a ninth schematic structural view of a volumetric three-dimensional bioprinting device according to some embodiments of the present disclosure;

FIG. 11 is a tenth schematic structural view of a volumetric three-dimensional bioprinting device according to some embodiments of the present disclosure;

FIG. 12 is a eleventh schematic structural view of a volumetric three-dimensional bioprinting device according to some embodiments of the present disclosure; and

FIG. 13 is a flowchart of a volumetric three-dimensional bioprinting method according to some embodiments of the present disclosure.

### DETAILED DESCRIPTION OF ILLUSTRATED EMBODIMENTS

To make persons skilled in the art understand the technical solutions of the present disclosure more clearly, the following embodiments are listed for description. It should be noted that the following embodiments do not limit the scope of protection of the present disclosure.

The volumetric three-dimensional bioprinting device provided by the invention is to project dynamically varying two-dimensional patterns to a specific portion of the bioink by a focusing unit; the printing bottle filled with the bioink rotates while being irradiated by the two-dimensional patterns, and the two-dimensional patterns are vertical to the rotating shaft of the printing bottle; calculating the projection modes from different rotation angles by Radon transform formula, similar to the process of computed tomography (CT), but applying it reversely. After the printing bottle is irradiated by the two-dimensional patterns from various angles, a three-dimensional distribution of accumulated light dose is generated, which causes specific portion of the bioink to be photo-crosslinked, thereby simultaneously forming a three-dimensional object that is used for further biomedical related research and application.

A first aspect of the embodiments of the present disclosure provides a volumetric three-dimensional bioprinting device. The volumetric three-dimensional bioprinting device provided by the present disclosure includes a printing bottle, a rotation unit, a focusing unit and a control unit; the printing bottle is used for containing bioink; the rotation unit is used for carrying and rotating the printing bottle at a preset speed; the focusing unit is used for enabling the energy beam to pass through at least one preset position of the printing bottle, so that bioink in the at least one preset position can be cured at the same time to form a three-dimensional object; the control unit and the rotation unit are electrically connected to the focusing unit.

In some embodiments of the invention, the focusing unit is used for projecting a plurality of dynamically varying two-dimensional patterns to a specific portion of the bioink corresponding to the preset position of the printing bottle.

In some embodiments of the invention, the volumetric three-dimensional bioprinting device continuously rotates the printing bottle containing the bioink by the rotation unit, projects a plurality of dynamically varying two-dimensional patterns to a specific portion of the bioink by the focusing unit so that the two-dimensional patterns is perpendicular to the rotation axis of the printing bottle, and determines a projection mode matched with a rotation speed of the printing bottle according to a Radon transformation formula to control the focusing unit to output the energy beam in the projection mode by the control unit. After the bioink in the printing bottle is irradiated by the energy beam for a certain time, a three-dimensional distribution of the accumulated light dose will be generated, resulting in photo-crosslinking of the specific portion of the bioink, and then a three-dimensional object is formed at the specific portion at the same time.

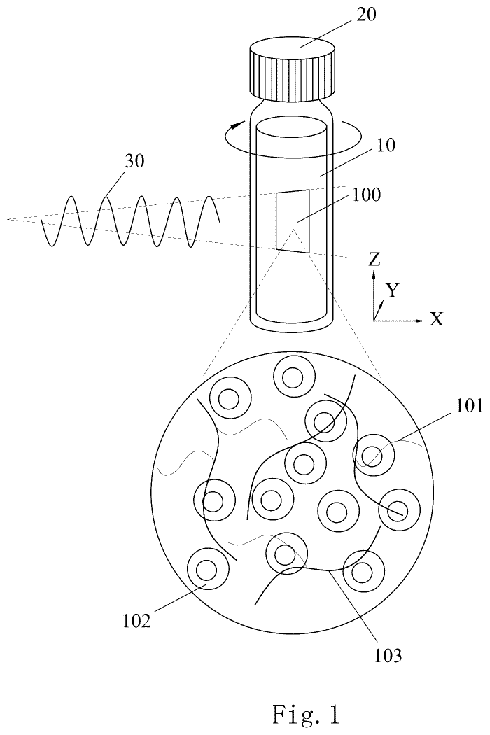

FIG. 1 shows a schematic view of a bioprinting process of a volumetric three-dimensional bioprinting device according to an embodiment of the invention. As shown in FIG. 1, bioink 10 is contained in a medium chamber, i.e., a printing bottle 20, and the printing bottle 20 is rotated by a rotation unit; an energy beam 30 approaches the printing bottle 20 at a certain speed, and after the bioink 10 is focused by the energy beam 30 for a certain time, the photo initiator 101 contained therein may be cross-linked, so that the microorganisms 102 in the bioink 10 are solidified together with the polymer 103, thereby forming a three-dimensional object 100.

In an embodiment of the invention, the energy source of the energy beam 30 is at least one of a bulb, a light emitting diode, an LCD or a laser emitter.

In an embodiment of the invention, the energy beam 30 passes through the printing bottle after being focused by a convex lens or a plane mirror.

In an embodiment of the invention, the wavelength of the energy beam is 390-780 nm.

In an embodiment of the invention, the focal length of the energy beam is 4-9.2 cm.

It should be noted that the selected energy source and the wavelength of the energy beam 30 are related to the selected photocurable material.

In an embodiment of the invention, the rotation unit includes a moving platform, and the rotation unit adjusts the spatial positions of the energy beam 30 and the printing bottle 20 by the moving platform.

In an embodiment of the invention, the rotation unit can adjust the spatial positions of the energy beam 30 and the printing bottle 20 by changing the axial distances of the X-axis, the Y-axis, and the Z-axis of the moving platform.

In an embodiment of the invention, the rotation unit can adjust the energy beam to be closer to or further away from the printing bottle by changing the axle distance of the X-axis of the moving platform. Referring to FIGS. 3 and 5, for example, the printing bottle is driven by the moving platform to move closer to or further away from the light source (i.e., the energy beam 30) along the direction of the X-axis, thereby adjusting the energy beam to be closer to or further away from the printing bottle.

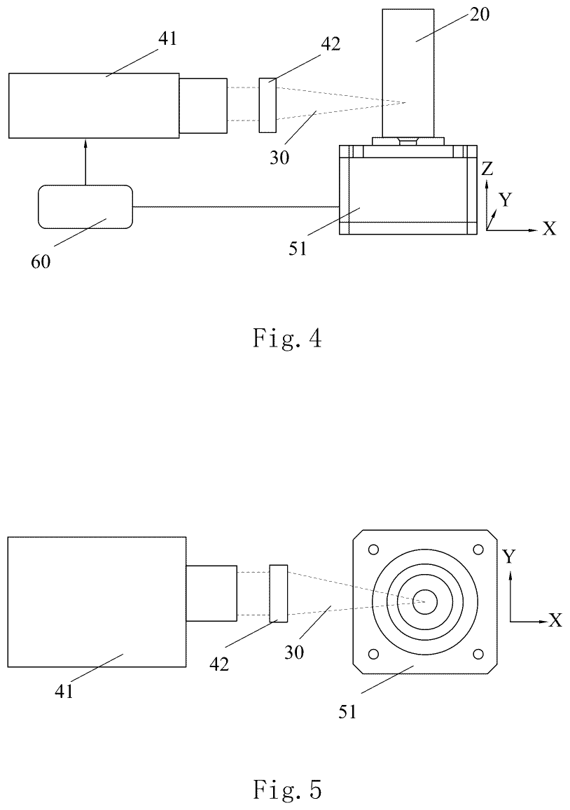

In an embodiment of the invention, the rotation unit can adjust the energy beam to a position closer to or further away from the upper portion or the lower portion of the printing bottle by changing the axle distance of the Z-axis of the moving platform. Referring to FIG. 4, for example, the printing bottle is driven by the moving platform to move along the direction of the Z-axis, so that the energy beam is adjusted to a position closer to the upper portion of the printing bottle or closer to the lower portion of the printing bottle, or the energy beam is adjusted to a position further away from the upper portion of the printing bottle or further away from the lower portion of the printing bottle.

In an embodiment of the invention, the rotation unit can adjust the energy beam to a position closer to or further away from the left portion or the right portion of the printing bottle by changing the axle distance of the Y-axis of the moving platform. Referring to FIG. 3, for example, the printing bottle is driven by the moving platform to move along the direction of the Y-axis, so that the energy beam is adjusted to a position closer to the left portion of the printing bottle or closer to the right portion of the printing bottle, or the energy beam is adjusted to a position further away from the left portion of the printing bottle or further away from the right portion of the printing bottle.

It should be noted that the energy beam may approach the printing bottle from the east side, west side, south side, north side, south-east side, south-west side, north-east side or north-west side of the printing bottle, so that the energy beam can approach the printing bottle from various directions.

According to some embodiments of the invention, the printing bottle is made of transparent plastic or glass material.

It should be noted that, the printing bottle 20 is not limited to be made of plastic material and glass material, and may also be made of any other transparent material, so as to facilitate the entry of the energy beam into the printing bottle.

In some embodiments of the invention, the bioink 10 includes a polymer precursor to be photocured and microorganism 102.

It should be noted that the microorganism 102 may be, but is not limited to, cells or bacteria.

In some embodiments of the invention, the bioink 10 includes a polymer precursor to be photocured and at least one of cells or bacteria.

It should be noted that the bioink 10 may include a polymer precursor to be photocured and cells, or a polymer precursor to be photocured and bacteria, or a polymer precursor to be photocured and cells and bacteria. The cells may be of various types and are not limited to one type, and the bacteria may also be of various types and is not limited to one type.

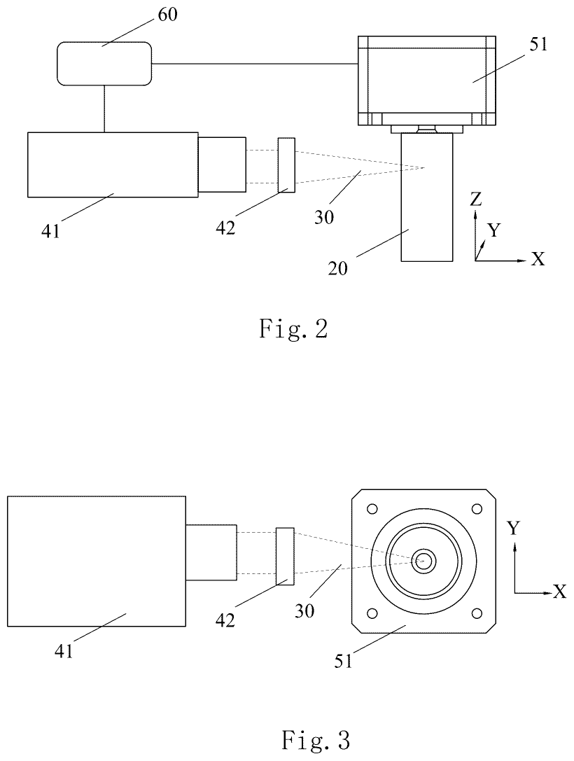

FIGS. 2-5 illustrate schematic structural views of a volumetric three-dimensional bioprinting device according to an embodiment of the present disclosure. Referring to FIGS. 2-5, the focusing unit includes a projector 41 and a lens 42, the rotation unit includes a rotation platform 51 disposed above or below the printing bottle 20, the projector 41 and the lens 42 are arranged on one side of the printing bottle 20 from far to near, the projector 41 and the rotation platform 51 are electrically connected to the control unit 60; the projector 41 projects the energy beam 30 through one side thereof that is closer to the lens 42, and the energy beam 30 can be focused by the lens 42 to a particular position in the printing bottle 20.

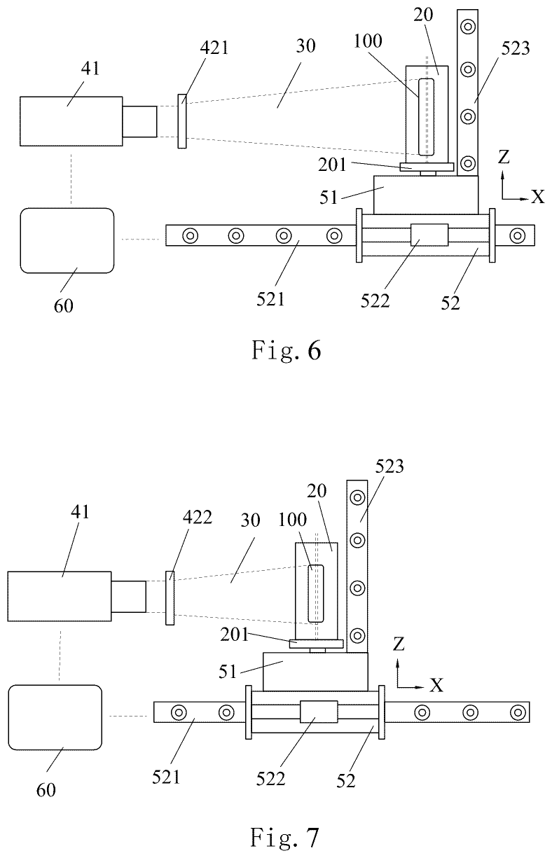

FIGS. 6-9 illustrate a plurality of schematic structural views of a volumetric three-dimensional bioprinting according to another embodiment of the present disclosure. As shown in FIGS. 6-9, the rotation unit includes a moving platform 52, the moving platform 52 is connected to the rotation platform 51, and the moving platform 52 drives the rotation platform 51 to move when moving, so that the printing bottle 20 is driven to move. Specifically, the moving platform 52 includes an X-axis moving slide rail 521, a Y-axis moving slide rail 522 and a Z-axis moving slide rail 523, and the moving platform 52 is driven to move in the three directions of the X-axis moving slide rail 521, the Y-axis moving slide rail 522 and the Z-axis moving slide rail 523 for changing the axle distances of the X-axis, the Y-axis, and the Z-axis of the moving platform 52, respectively. The moving platform 52 may be driven to move in the three directions by a motor or a human, so that the axle distances of the X-axis, the Y-axis, and the Z-axis of the moving platform 52 can be changed.

In this embodiment, the printing bottle 20 is detachably connected to the rotation platform 51 by a printing bottle holder 201. For example, the printing bottle holder 201 is fixedly embedded in the rotation platform 51, and the printing bottle holder 201 is provided with connection ports of different sizes and each of the connection ports is used to connect a printing bottle 20 of corresponding size. Alternatively, the printing bottle holder 201 and the rotation platform 51 are with each other in a detachable manner, and printing bottle holders of different structures are provided with connection ports of different sizes each of which is connected with a printing bottle of corresponding size.

Specifically, the printing bottle holder 201 is embedded into the rotation platform 51, the motor in the rotation platform 51 drives the printing bottle holder 201 to rotate clockwise or counterclockwise, thereby driving the printing bottle 20 to rotate at the same angular speed as that of the printing bottle holder 201. In addition, the printing bottle holder 201 can be replaced to fit a printing bottle 20 of different size to print a model of larger or smaller size in the X, Y, and Z-axis directions.

Therefore, the movement of the rotation platform 51 and the printing bottle 20 in the X, Y, and Z-axis directions is controlled by controlling the moving platform 52, so as to control the relative position of the printing bottle 20 and the projector 41.

It can be understood that the intensity of energy beam (e.g., radiant intensity; described below in terms of radiant intensity as the intensity of the energy beam) attenuates with the increase of the distance, and generally follows the inverse-square law (the inverse-square law is a law describing the change of the radiation intensity of a point light source with the distance), that is, the radiant intensity is in an inverse proportion to the square of the distance. Therefore, the farther the distance, the higher the radiant intensity needs to be.

For example, the radiant intensity will change when the light projected by the projector reaches the center position of the printing bottle at different distances, for example, the radiant intensity is 150 mW at a distance of 1 cm, and needs to be increased to 10 W at a distance of 15 cm. This indicates that the power of the light source needs to be adjusted according to the actual distance, so as to ensure the light curing effect. In the case that the intensity of the light source remains unchanged, the farther the light beam is away from the printing bottle, the more obvious the attenuation of the radiant intensity will be after the light beam reaches the printing bottle. Therefore, with respect to different distances, it is necessary to appropriately adjust the radiant intensity, so as to satisfy the radiant density required by the bioink to realize fast, contactless three-dimensional printing. Generally, the distance between the light beam and the printing bottle from the light source through the optical lens is 1 cm-15 cm, and the corresponding radiant intensity needs to be 150 mw-10 w, so as to ensure that the bioink in the printing bottle can be photocured within 10-120 s and achieve fast non-contact printing. Similarly, under the condition that the intensity of the light source is not changed, the distance from the printing bottle to the light source can be adjusted in order to ensure the radiant intensity of the light beam after the light beam reaches the printing bottle from the light source.

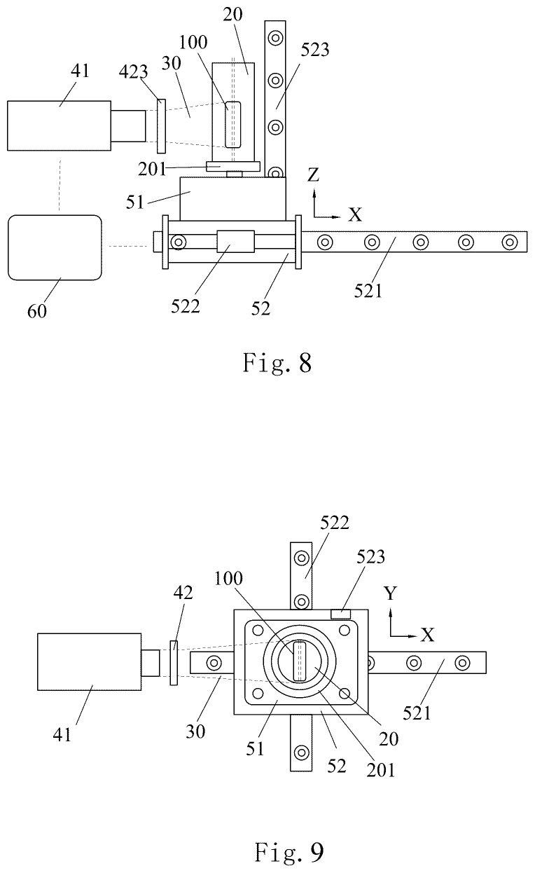

In addition, the lens is important for the uniformity of light, and the lens can provide a uniform radiant intensity in the target area, so as to ensure the uniform curing of the bioink. In the embodiment, a condensing lens (such as a convex lens) is used to concentrate light at a target area, or a parallel light lens (such as a plano-convex lens) is used to maintain the parallelism and uniformity of a light beam. In addition, the focal length of the lens determines the ability of the lens to focus the light beam to a target point. In the present embodiment, the focal length of the light source is controlled by using different (different types, different focal lengths, or both) lenses, for example, the first lens 421 shown in FIG. 6, the second lens 422 shown in FIG. 7, and the third lens 423 shown in FIG. 8, and the first lens 421, the second lens 422, and the third lens 423 may be different types of lenses or have different focal lengths.

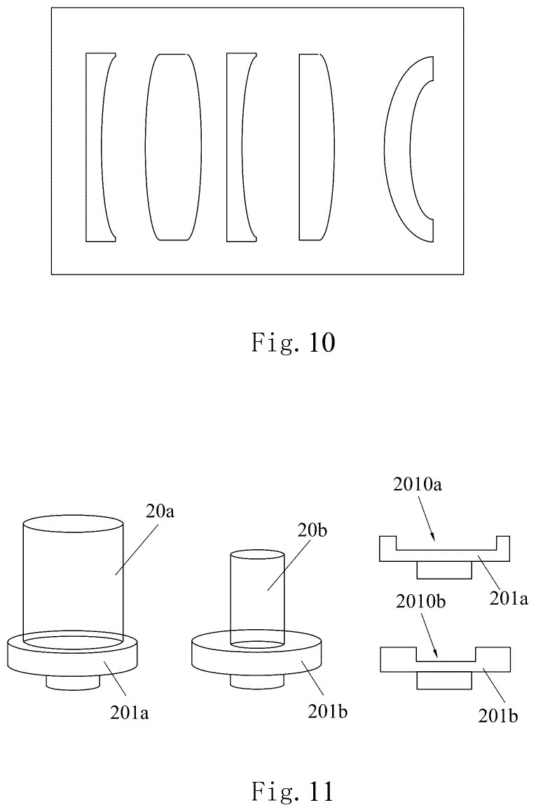

It can be understood that, each of the first lens 421, the second lens 422 and the third lens 423 may be represented as an individual lens (e.g., a concave-convex lens, a plano-concave lens, or a double-curved lens lamp, etc.), or may also be represented as a lens group, e.g., the lens group may be a combination of at least two of a concave-convex lens, a plano-concave lens and a double-curved lens lamp, etc., as shown in FIG. 10.

Therefore, the technical solution disclosed in the present disclosure selects lenses of different focal lengths and types to meet the requirements of different distances between the light source and the bioink, and to meet the requirements of different light source wavebands required by bioink for implementing rapid and contactless three-dimensional forming printing.

In one aspect, the technical solution disclosed in the present disclosure controls the distance between the printing bottle 20 and the light source by the moving platform 52, and controls the focal plane of the projected image by selecting a lens that is adapted such that the energy beam (e.g., light beam) can be focused on the focal plane. Since the energy beam of non-focal plane is dispersed, the lower energy beam cannot cure the photocurable bioink. Therefore, the present disclosure employs the technical solution described above, which improves the concentration of the energy beam greatly, avoids lower curing efficiency caused by the dispersion of the energy beam, and improves the printing resolution significantly.

In other aspect, the technical solution disclosed in the present disclosure achieves the printing of models (three-dimensional objects) of different sizes by employing different lenses, adjusting the axial distances of the X-axis, the Y-axis, and the Z-axis of the moving platform 52, and replacing printing bottles of different sizes.

Firstly, in addition to controlling the position of a focal plane of a projected image, different lenses can also influence the divergence or focusing of an energy beam, thereby controlling the size of the projected image. For example, when the lens diverges the energy beam, the farther the projected image is from the projector, the larger the size of the imaging.

Then, the rotation platform 51 and the printing bottle 20 are controlled to move by adjusting the axial distance of the X-axis, the Y-axis, and the Z-axis of the moving platform 52, so that the focal plane of the projected image is caused to concentrate at the position of the center of the printing bottle 20, thereby achieving an optimal effect for each printing and reducing printing defects caused by positional deviation.

Finally, in order to adapt to printing of different model sizes, printing bottles of different sizes (e.g., diameters) can be placed by replacing printing bottle holders of different structures. For example, as shown in FIG. 11, a first print bottle holder 201a having a larger connection ports 2010a can be connected to a larger-sized printing bottle 20a so that a large-sized model can be built in the larger-sized printing bottle 20a. If a smaller-size model needs to be built, another printing bottle holder 201b with a smaller connection ports 2010b may be replaced to connect a smaller-size printing bottle 20b.

In another aspect, the technical solution disclosed in the present disclosure controls the intensity of the light beam passing through the printing bottle by adjusting the radiant intensity of the projector (serving as a light source), adjusting the distance between the projector 41 and the printing bottle 20 (e.g., adjusting the axial distance of the X-axis of the moving platform 52), and employing lenses of different types and focal lengths. For example, the farther the light source is away from the printing bottle 20, the larger the size of the object to be printed, and the more obvious the light energy attenuation. In this case, in some embodiments of the present disclosure, by controlling the radiant intensity of the light source and selecting lenses of different types and focal lengths, the intensities of the light beams arriving at the bioink in the printing bottle at different distances from the light source can be always consistent.

Therefore, the technical solution disclosed in the present disclosure employs lenses of different types and focal lengths, controls the printing bottle 20 and the rotation platform 51 to move by the moving platform 52 so as to adjust the spatial position of the energy beam and the printing bottle 20, and replaces printing bottles of different sizes, so that the intensity of the energy beam, the relative distance between the energy beam and the printing bottle, and the printing size of the three-dimensional object can be balanced, and the three-dimensional model can be quickly printed without contact in the printing bottle 20.

As can be appreciated, in the embodiment of the present disclosure, the power of the light source is preferably 150 mW-20 W, the diameter of the printing bottle is preferably 0.1 cm-10 cm, and the thickness of the printing bottle is preferably 1 mm. The focal length of the lens is preferably 20 mm-100 mm, and the focal length of the energy beam is controlled by the focal length of the lens.

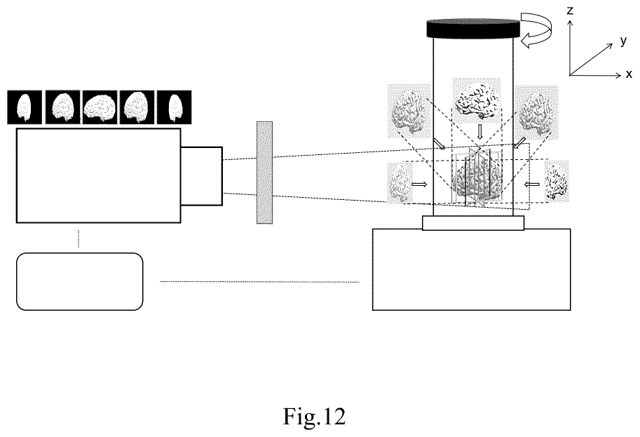

As can be appreciated, referring to FIG. 12, in the embodiment, first, determining projection modes (comprising projected images from different rotation angles, each of the projected images is a two-dimensional image, which is also referred to as a two-dimensional pattern) which are matched the rotation speed of the printing bottle for the three-dimensional model according to a Radon transformation formula, so as to obtain a series of longitudinal two-dimensional pattern slices of the three-dimensional model that are dynamically varied. The series of two-dimensional pattern slices is closely related to the shape, thickness of the three-dimensional model being provided (or, to be printed). Then, all the two-dimensional pattern slices are combined into a two-dimensional pattern sequence, and finally, the two-dimensional pattern slices in the two-dimensional pattern sequence are projected into a printing bottle which is rotated at a certain speed, so that the bioink containing cells in the printing bottle can be rapidly and simultaneously photo-cured in all directions to form a three-dimensional object.

A second aspect of the embodiments of the present disclosure provides a volumetric three-dimensional bioprinting method.

The volumetric three-dimensional bioprinting method includes the following steps: rotating a printing bottle continuously at a preset speed by a rotation unit, the printing bottle containing bioink; enabling an energy beam to pass through at least one preset position of the printing bottle by a focusing unit, so that the bioink in the at least one preset position can be cured to form a three-dimensional object at the same time.

In the embodiment of the present disclosure, the printing method further includes: determining projection modes of the focusing unit by a control unit, the projection modes relate to a preset speed and direction of the rotation unit.

In the embodiment of the present disclosure, when the focusing unit controls the energy beam having the two-dimensional patterns to pass through the at least one preset position of the printing bottle in the projection modes, each of the two-dimensional patterns in the energy beam is perpendicular to the rotation axis of the printing bottle. It should be noted that, the wavelength of the energy beam may be 390-780 nm; the focal length of the energy beam may be 4-9.2 cm; and the preset speed may be 5-25°/s.

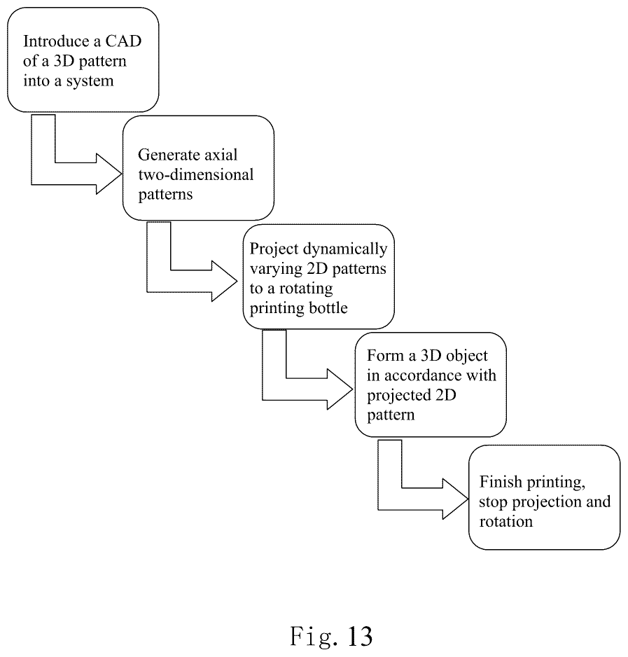

FIG. 13 shows a schematic flowchart of a volumetric three-dimensional bioprinting method according to an embodiment of the present disclosure. As shown in FIG. 13, the method for volumetric three-dimensional bioprinting includes steps of: introducing a CAD of a three-dimensional pattern into a system via a computer device electrically connected to a control unit, the system generating axial two-dimensional patterns according to the CAD, and transmitting the axial two-dimensional patterns to a projector of a focusing unit via the control unit; controlling a moving platform and a rotation platform by a control unit; projecting the two-dimensional patterns that are dynamically varied to a rotating printing bottle by a projector after receiving the two-dimensional patterns; forming a three-dimensional object that has a three-dimensional structure at the preset portion of the bioink at the same time according to the projected two-dimensional patterns after the bioink in the printing bottle having been focused for a certain time.

A third aspect of the embodiments of the present disclosure provides an application of the volumetric three-dimensional bioprinting device described above in three-dimensional bioprinting, tissue engineering and/or regenerative medicine.

Therefore, the volumetric three-dimensional biological printing device of the present disclosure realizes the simultaneous formation of three-dimensional object through the cooperation of the printing bottle, the rotation unit, the focusing unit and the control unit, and the printing device conducts contactless printing with the formed three-dimensional object, thereby preventing biological contamination; at the same time, the volumetric three-dimensional bioprinting device of the present disclosure realizes the printing of a three-dimensional object with a size of a centimeter level in tens of seconds, and has the characteristic of a high printing speed; the volumetric three-dimensional bioprinting device of the present disclosure has the characteristics of being applicable to the printing of complex structures, good in printing quality, suitable for industrial popularization and use and the like.

What is claimed is:

1. A volumetric three-dimensional bioprinting device, comprising:
a printing bottle for containing bioink;
a rotation unit for carrying and rotating the printing bottle at a preset speed;
a focusing unit for enabling an energy beam to pass through at least one preset position of the printing bottle, so that the bioink in the at least one preset position can be cured at the same time to form a three-dimensional object, wherein the energy beam comprises a plurality of two-dimensional patterns that are dynamically varied, and when the energy beam passes through the at least one preset position of the printing bottle, each of the plurality of the two-dimensional patterns is perpendicular to a rotation axis of the printing bottle; and
a control unit electrically connected to the rotation unit and the focusing unit, wherein the control unit determines projection modes which are matched with the rotation speed of the printing bottle according to a Radon transformation formula, and then controls the focusing unit to output the energy beam in the projection modes.

2. The volumetric three-dimensional bioprinting device according to claim 1, wherein the rotation unit is provided with a moving platform, and the rotation unit adjusts spatial positions of the energy beam and the printing bottle by changing axial distances of an X-axis, a Y-axis, and a Z-axis of the moving platform.

3. The volumetric three-dimensional bioprinting device according to claim 2, wherein the rotation unit adjusts the energy beam to be closer to or further away from the printing bottle by changing the axle distance of the X-axis of the moving platform.

4. The volumetric three-dimensional bioprinting device according to claim 2, wherein the rotation unit adjusts the energy beam to a position closer to an upper portion or a lower portion of the printing bottle by changing the axle distance of the Z-axis of the moving platform, and the rotation unit adjusts the energy beam to a position closer to a left portion or a right portion of the printing bottle by changing the axle distance of the Y-axis of the moving platform.

5. The volumetric three-dimensional bioprinting device according to claim 2, wherein the rotation unit further comprises a rotation platform disposed above or below the printing bottle.

6. The volumetric three-dimensional bioprinting device according to claim 5, wherein the focusing unit comprises a projector and a lens which are arranged on one side of the printing bottle from far to near, the projector and the rotation platform are electrically connected to the control unit, and the projector projects the energy beam through one side thereof that is closer to the lens.

7. The volumetric three-dimensional bioprinting device according to claim 5, wherein the moving platform is connected to the rotation platform, and the moving platform drives the rotation platform to move when moving, so that the printing bottle is driven to move.

8. The volumetric three-dimensional bioprinting device according to claim 7, wherein the moving platform is provided with an X-axis moving slide rail, a Y-axis moving slide rail and a Z-axis moving slide rail, and the moving platform is driven to move in directions of the X-axis moving slide rail, the Y-axis moving slide rail and the Z-axis moving slide rail for changing the axle distances of the X-axis, the Y-axis, and the Z-axis of the moving platform, respectively.

9. The volumetric three-dimensional bioprinting device according to claim 6, wherein the printing bottle and the rotation platform are connected with each other in a detachable manner, so that printing bottles with different sizes can be replaced.

10. The volumetric three-dimensional bioprinting device according to claim 9, wherein lenses of different focal lengths and types are selected or combined to accommodate requirement for different distances of the energy beam to the bioink.

11. The volumetric three-dimensional bioprinting device according to claim 9, wherein a distance between the printing bottle and the projector is adjusted by the mobile platform, and a lens with a focal length adapted to control a focal plane of a projected image is selected, so that the energy beam is focused on the focal plane.

12. The volumetric three-dimensional bioprinting device according to claim 9, wherein printing requirements of three-dimensional objects of different sizes are met by employing printing bottles of different sizes, selecting lenses of different focal lengths and types, and changing the axial distances of the X-axis, the Y-axis, and the Z-axis of the moving platform.

13. The volumetric three-dimensional bioprinting device according to claim 9, wherein an intensity of the energy beam that is passing through the printing bottle is controlled by adjusting an intensity of the energy beam projected by the projector, changing the axial distance of the X-axis of the moving platform, and employing lenses of different focal lengths and types.

14. The volumetric three-dimensional bioprinting device according to claim 1, wherein an energy source of the energy beam is at least one of a bulb, a light emitting diode, an LCD or a laser emitter.

15. The volumetric three-dimensional bioprinting device according to claim 1, wherein the energy beam passes through the printing bottle after being focused by a convex lens or a plane mirror.

16. The volumetric three-dimensional bioprinting device according to claim 1, wherein the wavelength of the energy beam is 390-780 nm.

17. The volumetric three-dimensional bioprinting device according to claim 1, wherein the printing bottle is configured to be rotated clockwise or counter-clockwise when the energy beam passes through the printing bottle.

18. The volumetric three-dimensional bioprinting device according to claim 1, wherein the printing bottle is made of transparent plastic or glass.

19. The volumetric three-dimensional bioprinting device according to claim 1, wherein the bioink comprises a polymer precursor to be photocured and at least one of cells or bacteria.
